(19) United States
(12) Patent Application Publication
(10) Pub. No.: US 2005/0136924 A1
(43) Pub. Date: Jun. 23, 2005

(54) Method, apparatus and system for enabling roaming mobile nodes to utilize private home IP addresses

(76) Inventors: Farid Adrangi, Lake Oswego, OR (US); Ranjit S. Narjala, Hillsboro, OR (US); Michael B. Andrews, Beaverton, OR (US); Prakash N. Iyer, Beaverton, OR (US)

Correspondence Address: INTEL CORPORATION, P.O. BOX 5326, SANTA CLARA, CA, 95056-5326, US

(21) Appl. No.: 10/728,553

(22) Filed: Dec. 4, 2003

(51) Int. Cl. H04Q 7/20

(52) U.S. Cl. 455/435.1; 370/338; 455/433; 370/400

(57) ABSTRACT

A method, apparatus and system extend a mobile home agent functionality to enable mobile nodes to use private address to correspond with nodes having public addresses. Specifically, according to an embodiment of the present invention, a home agent may be configured to assign a private address to a mobile node according to predetermined policies. In one embodiment, the packets from the mobile node may be destined for other mobile nodes that belong to the same administrative domain as the home agent. If so, the home agent may decapsulate and forward the packet directly to the destination mobile node. In an alternate embodiment, the packets from the mobile node may be destined for mobile nodes belonging to a different administrative domain than the home agent. If so, the home agent may decapsulate and perform address and port translation on the packet prior to transmission.

### FIELD

The present invention relates to the field of mobile computing, and, more particularly to a method, apparatus and system for extending mobile Internet Protocol (“IP”) home agent functionality to enable roaming mobile computing devices to use private (i.e. not globally routable) home Internet Protocol (“IP”) addresses.

### BACKGROUND

Use of mobile computing devices (hereafter “mobile nodes”) such as laptops, notebook computers, personal digital assistants (“PDAs”) and cellular telephones is becoming increasingly popular today. These mobile nodes enable users to move from one location to another (“roam”) (within and/or across wireless networks, and within and/or across IP subnets) while continuing to maintain their connectivity to the same destination network, whenever feasible. A subnet refers to a portion of an organization's network interconnected to other subnets by a routing element. Subnets are well known to those of ordinary skill in the art and further description thereof is omitted herein. Usage paradigms such as “always-on” connectivity and real-time applications such as voice-over-IP (“VoIP”) are driving most corporate (“enterprise”) networks today to facilitate fast and secure inter-IP subnet mobile computing.

In order to support free roaming, networks are starting to adopt one or more industry-wide IP mobility standards. More specifically, the Internet Engineering Task Force (“IETF”) has promulgated an application independent set of standards for IP version 4 (Mobile IPv4, IETF RFC 3344, August 2002, hereafter “Mobile IPv4,”) and IP version 6 (Mobile IPv6, IETF Mobile IPv6, Internet Draft draft-ietf-mobileip-ipv6-24.txt (Work In Progress), June 2003, hereafter “Mobile IPv6”) to enable mobile node users to move from one location to another (crossing IP subnets) while continuing to maintain their connectivity to the same target/destination network.

### BRIEF DESCRIPTION OF THE DRAWINGS

The present invention is illustrated by way of example and not limitation in the figures of the accompanying drawings in which like references indicate similar elements, and in which:

FIG. 1 illustrates a known corporate intranet structure;

FIG. 2 illustrates conceptually an embodiment of the present invention;

FIG. 3 is a flow chart illustrating an embodiment of the present invention;

FIG. 4 is a packet flow diagram for packets destined for nodes registered with HA 130 and/or belonging to the same administrative domain as HA 130; and

FIG. 5 is a packet flow for packets destined for nodes belonging to a different administrative domain than HA 130.

### DETAILED DESCRIPTION

Embodiments of the present invention provide a method, apparatus and system for extending mobile IP home agent (“HA”) functionality to enable mobile IP nodes to utilize private (i.e. not globally routable) home addresses to communicate with correspondent nodes on any administrative domain.. Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

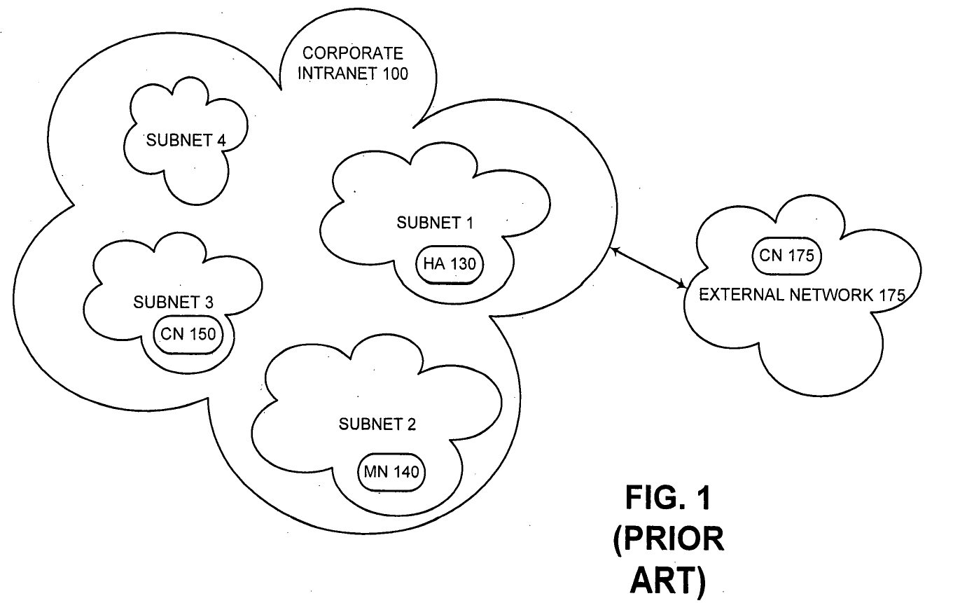

FIG. 1 illustrates a typical corporate intranet (“Corporate Intranet 100”) structure. Corporate Intranet 100 may include both wired and wireless networks and may comprise multiple subnets. Mobile nodes that conform to mobile IP standards today may roam freely across subnets within Corporate Intranet 100. These mobile nodes (e.g., “MN 140”) typically apply mobile IP to all mobile IP data transactions and are therefore able to maintain their current transport (“Transport Control Protocol” or “TCP”) connections and constant reachability. The term “apply mobile IP” is well known to those of ordinary skill in the art, and typically includes the application of mobile IP headers to packets prior to transmission and correspondingly, the removal of these mobile IP headers when packets are received. When MN 140 exits its home subnet on Corporate Intranet 100, it may register with a home agent (“HA 130”). During the registration process, MN 140 informs HA 130 of MN 140's home address (i.e., its invariant address) and its “care-of address” (hereafter “COA”), namely MN 140's address on its new subnet. MN 140 may obtain COAs via Dynamic Host Configuration Protocol (“DHCP”) or other similar protocols. In the event MN 140 does not have a statically assigned home address, it may also request a home address from HA 130 via a Network Address Identifier (“NAI”) extension, as specified in IETF RFC 2794, March 2000. In this scenario, HA 130 may provide MN 140 with a home address in its registration reply. HA 130 may obtain this address from HA 130's IP address pool, by requesting the home address from a DHCP server via a DHCP (or other similar protocol) request, and/or by other such techniques.

HA 130 thereafter intercepts all IP packets from correspondent nodes (illustrated as “CN 150”) addressed to MN 140 and reroutes the packets to MN 140's COA using IP tunneling. IP tunneling is well known to those of ordinary skill in the art and further description thereof is omitted. Additionally, although CN 150 is illustrated as residing within Corporate Intranet 100, it will be readily obvious to those of ordinary skill in the art that CN 150 may reside on any foreign subnet, including subnets on networks outside Corporate Intranet 100 (e.g., External Network 175). As MN 140 moves from one foreign subnet to another, to ensure that HA 130 is able to properly route packets to MN 140, MN 140 must continuously update HA 130 with its new COA.

In the above example, HA 130 typically assigns MN 140 a publicly routable IPv4 address, i.e., an IP address that is defined by the IETF and universally accepted as an address that is recognized and/or globally routable on public networks. Using a publicly routable IP address, MN 140 may communicate with and receive communications from any node on Corporate Intranet 100 and/or External Network 175. IPv4 networks however, suffer from a shortage of routable IP addresses, and as a result, although nodes on External Network 175 may have unique IP addresses, there is significant motivation to use private addresses for MN 140's home address. A private home address may include a local address allocated by a domain administrator for use within a specific domain, but that is not otherwise recognized and/or routable on public networks.

In the mobile IP context, since MN 140 is assumed to be a roaming node, i.e., possibly moving between public and private networks, if MN 140 is assigned a private home address, it may not be consistently reachable. A private address may be used for an MN 140's home address in a limited usage model where MN 140 only needs to communicate with other nodes that belong to the same administrative domain as HA 130. The concept of administrative domains is well known to those of ordinary skill in the art and further description thereof is omitted herein. Thus, for example, MN 140 may communicate with CN 150 only if CN 150 is registered with HA 130 (i.e., the same home agent that MN 140 is registered with currently), or if CN 150 belongs to the same administrative domain as HA 130. This may be accomplished by having HA 130 reverse tunnel packets transmitted from MN 140 and CN 150 to HA 130. MN 140 may not, however, communicate with CN 150 if CN 150 is on a different administrative domain. Although communications from MN 140 to CN 150 may succeed, any responses from CN 150 (addressed to MN 140's private address) may be dropped as an intermediate router may not know how to forward the packet destined for an invalid public address. It is well known to those of ordinary skill in the art that there are no known techniques that currently enable a roaming mobile node to utilize private home addresses to communicate with correspondent nodes on any other administrative domain (including receiving responses from the correspondent node).

Embodiments of the present invention extend HA 130's functionality to enable MN 140 to utilize a private home address to communicate with CN 150, regardless of CN 150's parent administrative domain. MN 140's home address may be statically assigned by a system administrator and/or obtained dynamically from HA 130 during registration. When MN 140 registers with HA 130, if it does not already have a home address, it may request a home address from HA 130 using a NAI extension in its registration request. HA 130 may assign a home address to MN 140 from a pool of addresses, by obtaining an address from a DHCP server and/or other such techniques. According to one embodiment of the present invention, HA 130 may be configured to assign a public or private home address to MN 140 according to predetermined policies. If, according to the policy, HA 130 assigns a private home address, HA 130 may be required to enforce the policy of having MN 140 reverse tunnel outbound mobile IP traffic through HA 130. More specifically, in order to assign a private address to MN 140, in one embodiment MN 140 must set the ‘T’ bit in its registration request to HA 130. The ‘T’ bit signifies that MN 140 will be using reverse tunneling for outbound packets. If the ‘T’ bit is not set in the registration request from MN 140, HA 130 may send MN 140 a registration reply with an appropriate reject error code that indicates the problem to MN 140.

In one embodiment, after registration and assignment of a private home address, MN 140 may send and receive packets routed via HA 130. When HA 130 receives a packet from MN 140 (in reverse tunneled format), it may decapsulate the packet and examine the destination IP address of the inner packet (e.g., to CN 150). If CN 150 is registered with HA 130 and/or belongs to the same administrative domain, HA 130 may tunnel the packet directly to CN 150. If CN 150 is not registered with HA 130 and/or belongs to a different administrative domain, in one embodiment, HA 130 may apply address and port translation to the decapsulated packet's IP and transport headers. Information pertaining to the translation may be maintained in HA 130's binding table. HA 130 may then forward the packet to CN 150 at its current address. According to one embodiment of the present invention, since HA 130 performs the mapping (i.e., address and port translation), the packet that arrives at CN 150 will include a public routable source address. CN 150 may therefore respond to MN 140 using this public routable source address, i.e., to HA 130. HA 130, in turn, may use the information in its binding table to route the packet back to MN 140.

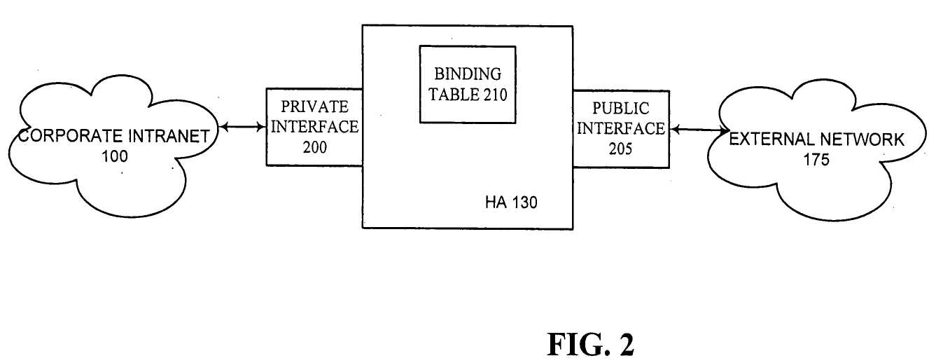

FIG. 2 illustrates conceptually an embodiment of the present invention. Specifically, as illustrated, HA 130 is a “dual-homed” HA, which includes two interfaces: Private Interface 200 for private addresses and Public Interface 205 for publicly routable addresses. It will be readily apparent to those of ordinary skill in the art that current HAs typically include only a single interface (per current mobile IP specifications, e.g., IETF RFC 3344), rather than the two interfaces in this embodiment of the present invention. HA 130 may additionally include Binding Table 210, which may include new fields in addition to the ones currently specified in the Mobile IPv4 specification. More specifically, entries in Binding Table 210 may include three more fields to hold the original layer 4 protocol identifier (obtained from the inner IP packet transmitted from MN 140 to CM 150), the original port number (also obtained from the inner IP packet transmitted from MN 140 to CN 150) and the translated/mapped port number assigned by HA 130 prior to forwarding the packet to CN 150. The term “layer 4 protocol identifier” is well known to those of ordinary skill in the art and further description thereof is omitted herein. HA 130 may include processing capability to replace the source IP address (i.e., MN 140's source IP address) with HA 130's routable IP address and the original source port number (i.e., transport ID) with HA 130's assigned port number. HA 130 may therefore process and route inbound packets (i.e., packets from CN 150 to HA 130) by looking up the received packet's protocol identifier and destination port number in its binding table. The binding entry will exist as long as MN 140 is registered with HA 130.

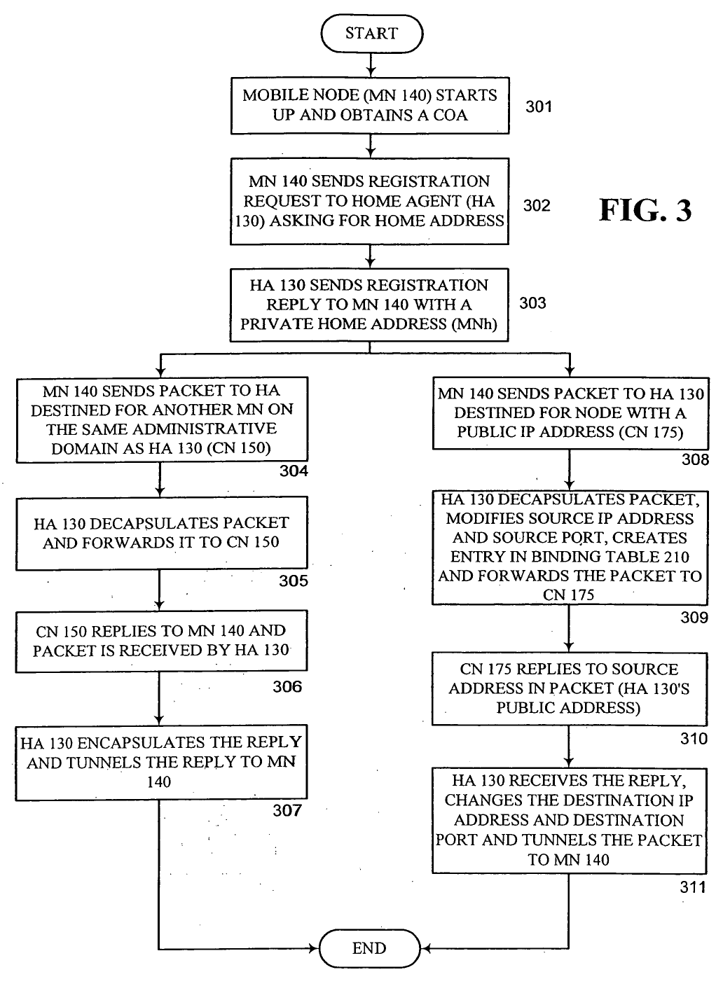

FIG. 3 is a flow chart illustrating an embodiment of the present invention. Although the following operations may be described as a sequential process, many of the operations may in fact be performed in parallel and/or concurrently. In addition, the order of the operations may be re-arranged without departing from the spirit of embodiments of the invention. In 301, MN 140 starts up and obtains a COA. MN 140 may then send a registration request to HA 130 requesting a home address in 302 and HA 130 may send MN 140 a registration reply in 303 with a private home address (MNh). MN 140 may then communicate using its private home address. If a packet from MN 140 is destined for a mobile node belonging to the same administrative domain as HA 130 (e.g., CN 150) in 304, HA 130 may intercept and decapsulate the packet in 305 and forward the packet to CN 150. CN 150 may respond to MN 140 in 306 and HA 130 may encapsulate the reply and tunnel it to MN 140 in 307.

If, however, MN 140 sends a packet destined for a node that belongs to a different administrative domain than HA 130 (e.g., CN 175) in 308, HA 130 may decapsulate the packet, modify the source IP address to HA 130's publicly routable IP address and source port address, create an entry in Binding Table 210 and forward the packet to CN 175 in 309. CN 175 may reply to the source IP address (i.e., HA 130's public address) in 310 and HA 130 may receive the reply, change the destination IP address to MNh, change the destination port to MN 140's port address, and tunnel the packet to MN 140 in 311.

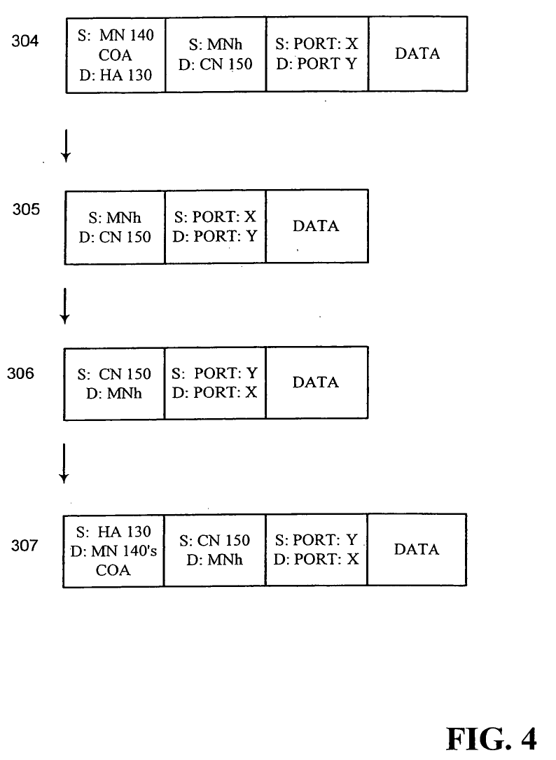

FIG. 4 is a packet flow diagram illustrating packet processing in FIG. 3 for packets destined for nodes that belong to the same administrative domain as HA 130. More specifically, the figure illustrates the packet flow for the activities in 304-307 in FIG. 3. As illustrated, in 304, when MN 140 send a packet destined for MN 150, the packet includes MNh, MN 140's private home address, as a source inner IP address and MN 150 as a destination inner IP address. Since mobile IP is applied to this packet, the packet may also include a source outer IP address of MN 140's COA and a destination outer IP address as HA 130. The port source may be X while the destination port may be Y. In 305, when HA 130 decapsulates the packet, it strips the outer IP headers (outer source and destination addresses) to determine the actual destination of the packet. HA 130 may then route the packet to MN 150 and when MN 150 replies in 306, HA 130 may tunnel the reply in 307 to MN 140 by adding the appropriate outer IP headers (outer source and destination addresses).

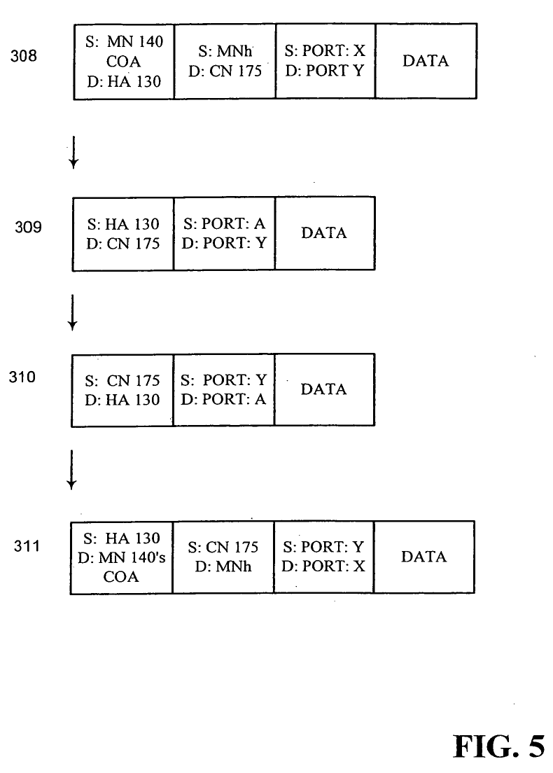

FIG. 5 is a packet flow diagram illustrating packet processing in FIG. 3 for packets with public routable destination IP addresses that are destined for nodes belonging to a different administrative domain than HA 130. More specifically, the figure illustrates the packet flow for the activities in 308-311 in FIG. 3. As illustrated, in 308, when MN 140 send a packet destined for CN 175 (i.e., a node belonging to a different administrative domain from HA 130 and MN 140), the packet includes MNh, MN 140's private home address, as a source inner IP address and CN 175 as a destination inner IP address. Since mobile IP is applied to this packet, the packet may also include a source outer IP address of MN 140's COA and a destination outer IP address as HA 130. The port source may be X while the destination port may be Y. In 309, when HA 130 decapsulates the packet, it strips the outer IP headers (outer source and destination addresses) to determine the actual destination of the packet. HA 130 may also modify the source IP address (from MNh to HA 130) and change the source port (from X to A). HA 130 may then route the packet to CN 175 and when CN 175 replies in 310, HA 130 may receive the reply in 311, change the destination IP address to MNh and the destination port to X and tunnel the reply to MN 140.

The mobile nodes and home agents according to embodiments of the present invention may be implemented on a variety of data processing devices. It will be readily apparent to those of ordinary skill in the art that these data processing devices may include various types of software, and may comprise any devices capable of supporting mobile networks, including but not limited to mainframes, workstations, personal computers, laptops, portable handheld computers, PDAs and/or cellular telephones. In an embodiment, mobile nodes may comprise portable data processing systems such as laptops, handheld computing devices, personal digital assistants and/or cellular telephones. According to one embodiment, home agents may comprise data processing devices such as personal computers, workstations and/or mainframe computers. In alternate embodiments, home agents may also comprise portable data processing systems similar to those used to implement mobile nodes.

According to an embodiment of the present invention, data processing devices may include various components capable of executing instructions to accomplish an embodiment of the present invention. For example, the data processing devices may include and/or be coupled to at least one machine-accessible medium. As used in this specification, a “machine” includes, but is not limited to, any data processing device with one or more processors. As used in this specification, a machine-accessible medium includes any mechanism that stores and/or transmits information in any form accessible by a data processing device, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, a data processing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. A host bus controller such as a Universal Serial Bus (“USB”) host controller may be coupled to the bus(es) and a plurality of devices may be coupled to the USB. For example, user input devices such as a keyboard and mouse may be included in the data processing device for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A method of managing allocation of a private home address to a mobile node, comprising:
receiving a registration request from the mobile node;
allocating one of a public home address and the private home address to the mobile node based on a predetermined policy;
if allocated the private home address, further:
decapsulating a packet from the mobile node to a correspondent node, the packet including a source address and an originating source port;
modifying the source address and the originating source port if the correspondent node belongs to a different administrative domain; and
forwarding the packet to the correspondent node.

2. The method according to claim 1 further comprising creating a binding entry in a binding cache.

3. The method according to claim 1 wherein modifying the source address and the originating source port comprises replacing the source address with a public routable source address and the originating source port with a source port of the public routable address.

4. The method according to claim 3 further comprising:
receiving a response packet from the correspondent node, the response packet including a public routable destination address;
replacing the public routable destination address in the response packet with the private home address of the mobile node;
replacing the destination port in the response packet with the originating source port; and
tunneling the response packet to the mobile node.

5. The method according to claim I wherein allocating the private home address to the mobile node further comprises at least one of allocating an address from a pool of addresses and obtaining the address from a Dynamic Host Control Protocol (“DHCP”) server.

6. The method according to claim I wherein decapsulating the packet further comprises intercepting the packet and examining a destination of the packet.

7. An article comprising a machine-accessible medium having stored thereon instructions that, when executed by a machine, cause the machine:
receive a registration request from a mobile node;
allocate one of a public home address and a private home address to the mobile node;
if allocating the private home address to the mobile node, the instructions are further capable of causing the machine to:
decapsulate a packet from the mobile node to a correspondent node, the packet including a source address and an originating source port;
modify the source address and the originating source port if the correspondent node belongs to a different administrative domain; and
forward the packet to the correspondent node.

8. The article according to claim 7 wherein the instructions, when executed by the machine, further create a binding entry in a binding cache.

9. The article according to claim 7 wherein the instructions, when executed by the machine, further modify the source address and the originating source port by replacing the source address with a public routable source address and the originating source port with a source port of the public routable address.

10. The article according to claim 9, wherein the instructions, when executed by the machine, further cause the machine to:
receive a response packet from the correspondent node, the response including a public routable destination address;
replace the public routable destination address in the response packet with the private home address of the mobile node;
replace the destination port in the response packet with the originating source port; and
tunnel the response packet to the mobile node.

11. The article according to claim 7 wherein the instructions, when executed by the machine, further cause the machine to allocate the private home address to the mobile node by at least one of allocating the private address from a pool of addresses and obtaining the address from a Dynamic Host Control Protocol (“DHCP”) server.

12. The article according to claim 7 wherein the instructions, when executed by the machine, further cause the machine to decapsulate the packet further by intercepting the packet and examining a destination of the packet.

13. A home agent for managing allocation of a private home address to a mobile node, comprising:
a private interface capable of receiving a registration request from the mobile node;
a processing module capable of allocating one of a public home address and the private home address to the mobile node, wherein if allocating the private home address, the processing module is further capable of decapsulating a packet from the mobile node to a correspondent node, the packet including a protocol identifier, a source address and an originating source port, and modifying the source address and the originating source port if the correspondent node belongs to a different administrative domain; and
a public interface capable of forwarding the packet to the correspondent node.

14. The home agent according to claim 13 further comprising a binding table, and wherein the processing module is further capable of creating a binding entry in the binding table.

15. The home agent according to claim 13 wherein the processing module is further capable of modifying the source address and the originating source port by replacing the source address with a public routable source address and the originating source port with a source port of the public routable address.

16. The home agent according to claim 15 wherein the public interface is further capable of receiving a response packet from the correspondent node, the response including a public routable destination address.

17. The home agent according to claim 16 wherein the processing module is further capable of replacing the public routable destination address in the response packet with the private home address of the mobile node and replacing the destination port in the response packet with the originating source port.

18. The home agent according to claim 17 wherein the private interface is further capable of tunneling the response packet to the mobile node.

19. The home agent according to claim 13 wherein the processing module is further capable of allocating the private home address to the mobile node by at least one of allocating the private home address from a pool of addresses and obtaining the private home address from a Dynamic Host Control Protocol (“DHCP”) server.

20. The home agent according to claim 13 wherein the processing module is further capable of decapsulating the packet by intercepting the packet and examining a destination of the packet.

21. A system for routing a packet, comprising:
a mobile node capable of generating a registration request; and
a home agent coupled to the mobile node, the home agent capable of allocating one of a public home address and a private home address to the mobile node, wherein if allocating the private home address, the home agent is further capable of decapsulating a packet from the mobile node to a correspondent node, the packet including a protocol identifier, a source address and an originating source port, modifying the source address and the originating source port if the correspondent node belongs to a different administrative domain, and forwarding the packet to the correspondent node.

22. The system according to claim 21 wherein the home agent is further capable of creating a binding entry in a binding cache.

23. The system according to claim 21 wherein the home agent is further capable of modifying the source address and the originating source port by replacing the source address with a public routable source address and the originating source port with a source port of the public routable address.

24. The system according to claim 23 wherein the home agent is further capable of receiving a response packet from the correspondent node, the response packet including a public routable destination address, replacing the public routable destination address in the response packet with the private home address of the mobile node, replacing the destination port in the response packet with the originating source port, and tunneling the response packet to the mobile node.

25. The system according to claim 21 wherein the home agent is further capable of allocating the private home address by at least one of allocating the private home address from a pool of addresses and obtaining the private home address from a Dynamic Host Control Protocol (“DHCP”) server.

26. The system according to claim 21 wherein the home agent is further capable of decapsulating the packet by intercepting the packet and examining a destination of the packet.
